(19) United States
(12) Patent Application Publication
(10) Pub. No.: US 2025/0299519 A1
(43) Pub. Date: Sep. 25, 2025

(54) Computer-Implemented Method and Device for Designing a Data Collection Campaign for a Motor Vehicle

(71) Applicant: Bayerische Motoren Werke Aktiengesellschaft, Muenchen (DE)

(72) Inventors: Andreas BAUMGARTL, Muenchen (DE); Tim RAKOWSKI, Hebertshausen (DE); Loren SCHWARZ, Muenchen (DE)

(21) Appl. No.: 18/862,925

(22) PCT Filed: Mar. 28, 2023
(86) PCT No.: PCT/EP2023/057936

§ 371 Date: Nov. 4, 2024

(30) Foreign Application Priority Data
May 5, 2022 (DE) 10 2022 111 180.6

(51) Int. Cl. G07C 5/08; G07C 5/00

(52) U.S. Cl. CPC G07C 5/085; G07C 5/008

(57) ABSTRACT

A computer-implemented method for designing a data collection campaign for a motor vehicle. The method includes determining a maximum storage capacity of a ring memory of a motor vehicle; determining information needed to achieve a predefined objective of the data collection campaign; determining data present in the motor vehicle; selecting the data to be stored in the ring memory via the data collection campaign from the data present in the motor vehicle based on the maximum storage capacity of the ring memory and the information needed to achieve the predefined objective of the data collection campaign; and defining the data collection campaign based on the selected data to be stored in the ring memory by means of the data collection campaign.

### BACKGROUND AND SUMMARY

The present disclosure relates to a computer-implemented method for designing a data collection campaign for a motor vehicle. Additionally or alternatively, a data processing device is provided that is configured to carry out the method at least in part. Additionally or alternatively, an (optionally automated) motor vehicle having the data processing device is provided. Additionally or alternatively, a computer program is provided that encompasses commands that, when the program is executed by a computer, cause said computer to carry out the method at least in part. Additionally or alternatively, a computer-readable medium is provided that encompasses commands that, when the commands are executed by a computer, cause said computer to carry out the method at least in part.

US2021271259A1 describes systems and methods for obtaining training data. An exemplary method encompasses receiving sensor data and applying a neural network to the sensor data. A trigger classifier is applied to an intermediate result from the neural network in order to ascertain a classifier rating for the sensor data. The classifier rating is taken as a basis, at least in part, for deciding whether at least some of the sensor data are supposed to be transmitted via a computer network. If the decision is positive, the sensor data are transmitted and used for generating training data.

Such systems and methods can be used as a so-called data collection mechanism in motor vehicles in order to provide a manufacturer of the motor vehicle with sensor data for the further development of partially automated or completely automated driving functions.

That is to say that such a data collection mechanism can be implemented in the motor vehicle as software. The purpose of data collection is not only to read sensor and function information directly at, or in, the motor vehicle but rather to store this information in a backend of a manufacturer of the motor vehicle wirelessly, in particular via the mobile radio network, so that a function development of the manufacturer of the motor vehicle can use the collected data.

A data collection order is triggered by a campaign that can be rolled out over the air, or wirelessly, to the motor vehicle that is in the field. These campaigns are heterogeneous as far as the required signals are concerned. Distinguishing features are e.g. inter alia a number of required signals, a recording period of the signals, signal resolution and/or a sampling of the signals.

As the signals are sent to the backend with a delay, a ring memory needs to be implemented in the motor vehicle, said ring memory not being arbitrarily expandable, however, i.e. having a maximum size due to a hardware design.

Against the background of this prior art, the object of the present invention is to specify a device and a method that are each suitable for overcoming at least the aforementioned disadvantages of the prior art. In particular, the aim is to specify a solution as to the ring memory being utilized for any campaign in an optimum manner.

The object is achieved by at least the features of the independent claims. The dependent claims include additional features of the invention.

Accordingly, the object is achieved by a computer-implemented method for designing a data collection campaign for a motor vehicle.

A computer-implemented method can be understood to mean a method that is carried out at least in part by a data processing device, or a computer.

The method encompasses determining a maximum storage capacity of a ring memory of a motor vehicle and determining information that is required in order to achieve a predefined aim of the data collection campaign.

The maximum storage capacity of the ring memory can be understood to mean a maximum volume of data that an empty ring memory can store. That is to say that the maximum storage capacity is reached when newly added data, or data to be stored in the ring memory, result in other data already stored in the ring memory needing to be overwritten.

The predefined aim can be determined e.g. on the basis of a user input. That is to say that a user, e.g. a developer in a development department of a vehicle manufacturer, can use a programming interface (also called an application interface or application programming interface (API)), for example, to specify which driver assistance function is supposed to be checked for its functionality using the data collection campaign.

The method further encompasses determining data that are available in the motor vehicle.

The data that are available in the motor vehicle can be understood to mean a total of information that is available in the motor vehicle in the form of signals, which can be tapped off via an onboard electrical system or are used as variables for program execution within control units. They may be e.g. an output from entire driver assistance systems and/or individual sensors.

The method further encompasses selecting the data to be stored in the ring memory by means of the data collection campaign from the data available in the motor vehicle on the basis of the maximum storage capacity of the ring memory and the information that is required in order to achieve the predefined aim of the data collection campaign.

Based on the user input described above, the method can thus be used, e.g. based on expert knowledge or on the basis of data collection campaigns already defined, to define which data, or signals, from the entire volume of available data are supposed to be collected. If for example the functionality of the driver assistance function predetermined by the user is supposed to be checked using the data collected by means of the data collection campaign, the method can be used to determine which data are received by the driver assistance function and which data are output by the driver assistance function. Said data can then be selected as the data to be collected.

Finally, the method encompasses defining the data collection campaign on the basis of the selected data to be stored in the ring memory by means of the data collection campaign.

The data collection campaign is thus defined on the already selected data and is transferred to the data collection campaign, which is itself an algorithm, or a software component, in the form of rules, i.e. in the form of an algorithm. The data collection campaign can be specified e.g. using a so-called LUA script (a lightweight high-level programming language comprising multiple paradigms that was developed primarily for embedded applications). The data to be collected can be defined in these scripts.

The method affords the advantage that data collection campaigns can be defined that utilize a storage capacity of a ring memory in as optimum a manner as possible without this requiring the data collection campaign to be already known at the time of development of the motor vehicle.

Additional aspects of at least one embodiment are explained in detail below.

The data can be selected in such a way that the maximum storage capacity of the ring memory is not exceeded.

The data to be stored in the ring memory by means of the data collection campaign can be selected from the data available in the motor vehicle on the basis of the maximum storage capacity of the ring memory and the information that is required in order to achieve the predefined aim of the data collection campaign by determining which internal signals of the motor vehicle and/or of the onboard electrical system need to be tapped off, a recording period of the required signals, a signal resolution of the required signals and/or a sampling of the required signals.

That is to say that the aforementioned scripts can define not only the data, or signals, that are required but also specifically which signals are to be tapped off internally and from the onboard electrical system and also in what form. It may be e.g. that the signals need to be recorded, or collected, over a predetermined period only if a predetermined condition is satisfied (e.g. the driver assistance function to be tested outputs an error). Moreover, it may be sufficient for only every X-th frame of a signal to be collected or for the collected frames to be downscaled in order to reduce a storage space required for the respective frame. The method thus affords a solution as to how the aforementioned attributes can be used so that the ring memory capacity is not exceeded.

The method can encompass transmitting the defined data collection campaign, in particular by means of wireless communication, from a data processing device that has defined the data collection campaign to the motor vehicle.

The data processing device that has defined the data collection campaign may be e.g. a backend of the motor vehicle manufacturer. The campaigns can be distributed over a customer and/or development fleet, that is to say that the motor vehicle may be part of a vehicle fleet to which the defined data collection campaign is distributed, e.g. by way of a so-called CDC (Crowd Data Collection) mechanism.

The method can encompass storing data in the ring memory of the motor vehicle in accordance with the defined data collection campaign under the control of a data processing device of the motor vehicle.

The method can encompass transmitting, in particular by means of wireless communication, the data stored in the ring memory of the motor vehicle from the motor vehicle to a backend. The backend can also be referred to as a cloud and can encompass a data processing device operated by the motor vehicle manufacturer.

Furthermore, a system for data processing is described, encompassing means for carrying out the computer-implemented method described above.

The system may be a distributed system encompassing a data processing device operated e.g. by the motor vehicle manufacturer and, if necessary, can encompass a data processing device connected (in particular wirelessly) thereto.

The latter data processing device may be part of a motor vehicle. By way of example, the data processing device may be a data logger and/or an electronic control unit (ECU). The data processing device may be an intelligent processor-controlled unit that can communicate with other modules, e.g. by way of a central gateway (CGW), and that can form the vehicle electrical system, e.g. together with telematics control units, possibly via field buses, such as the CAN bus, LIN bus, MOST bus and FlexRay or by way of automotive Ethernet.

It is conceivable for the data processing device to encompass a memory unit that is used to store signals of the onboard electrical system and internal signals of the motor vehicle in accordance with the data collection campaign defined by the above methods. It is conceivable for the data processing device to transmit the collected data to the data processing device operated by the motor vehicle manufacturer.

The description above with regard to the method also applies, mutatis mutandis, to the system for data processing, and vice versa.

Furthermore, a motor vehicle comprising a data processing device and a ring memory is provided, the data processing device being configured to control storage of data in the ring memory of the motor vehicle in accordance with the data collection campaign defined by means of the computer-implemented method described above.

The motor vehicle may be a motorcar, in particular an automobile. The motor vehicle may be an automated motor vehicle configured to undertake longitudinal guidance and/or lateral guidance during automated driving of the motor vehicle at least in part and/or completely. The automated driving can be effected in such a way that the motor vehicle moves along (largely) autonomously.

The motor vehicle may be an autonomy level 0 motor vehicle, i.e. the driver undertakes the dynamic driving task even if assistive systems (e.g. ABS or ESP) are present.

The motor vehicle may be an autonomy level 1 motor vehicle, i.e. can have specific driver assistance systems that assist the driver in vehicle operation, for example adaptive cruise control (ACC).

The motor vehicle may be an autonomy level 2 motor vehicle, i.e. may be partially automated in such a way that functions such as automatic parking, keeping in lane, or lateral guidance, general longitudinal guidance, acceleration and/or braking are undertaken by driver assistance systems.

The motor vehicle may be an autonomy level 3 motor vehicle, i.e. may be conditionally automated in such a way that the driver does not have to continuously monitor the vehicle system. The motor vehicle independently performs functions such as activating the turn signal indicator, changing lane and/or keeping in lane. The driver can turn to other things, but if required is asked by the system to take over guidance within an advance warning time.

The motor vehicle may be an autonomy level 4 motor vehicle, i.e. may be highly automated in such a way that guidance of the motor vehicle is undertaken by the vehicle system on an ongoing basis. If the driving tasks are no longer coped with by the system, the driver can be asked to take over guidance.

The motor vehicle may be an autonomy level 5 motor vehicle, i.e. may be fully automated in such a way that the driver is not required in order to perform the driving task. Apart from stipulating the destination and starting the system, no human intervention is required.

The description above with regard to the method and the data processing device also applies, mutatis mutandis, to the motor vehicle, and vice versa.

Furthermore, a computer program can be provided. The computer program is distinguished in that it encompasses commands that, when the program is executed by a computer, cause said computer to carry out the method described above at least in part.

It is conceivable for the computer program to encompass, in particular exclusively, commands that, when the program is executed by a computer, cause said computer to carry out a data collection campaign defined by means of the method described above.

A program code of the computer program may be available in any desired code, in particular in a code suitable for controllers of motor vehicles, e.g. encompassing LUA scripts.

Furthermore, a computer-readable medium, in particular a computer-readable storage medium, is provided. The computer-readable medium is distinguished in that it encompasses commands that, when the program is executed by a computer, cause said computer to carry out the method described above at least in part.

It is conceivable for the computer-readable medium to encompass, in particular exclusively, commands that, when the commands are executed by a computer, cause said computer to carry out a data collection campaign defined by means of the method described above.

That is to say that a computer-readable medium can be provided that encompasses a computer program as defined above. The computer-readable medium may be any desired digital data storage device, for example a USB stick, a hard disk, a CD-ROM, an SD card or an SSD card.

The computer program does not necessarily have to be stored on a computer-readable storage medium such as this in order to be made available to the motor vehicle, but rather may also be sourced via the Internet or in some other external manner.

Furthermore, the present disclosure relates to the use of a data collection campaign that has been defined using the method described above in a motor vehicle.

The description above with regard to the method, the data processing device and the motor vehicle also applies, mutatis mutandis, to the computer program, the computer-readable medium and the use, and vice versa.

At least one embodiment is described below with reference to the Figures.

### BRIEF DESCRIPTION OF THE DRAWINGS

FIG. 1 schematically shows a system for data processing, encompassing means for carrying out a computer-implemented method for designing a data collection campaign for a motor vehicle, and

FIG. 2 schematically shows a flowchart for the computer-implemented method for designing the data collection campaign for the motor vehicle.

### DETAILED DESCRIPTION OF THE DRAWINGS

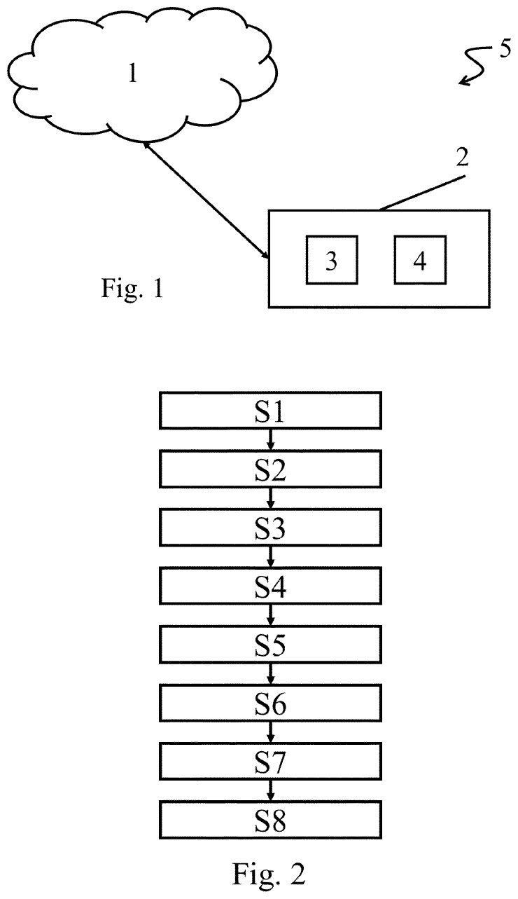

The distributed system for data processing 5 depicted in FIG. 1 encompasses a data processing device 1, in the present case in the cloud, and a motor vehicle 2 comprising a data processing device 3 and a ring memory 4. The system for data processing 5 is conditioned to carry out the computer-implemented method for designing a data collection campaign for the motor vehicle 2 encompassing collecting the data with the motor vehicle 2. This is also described in detail below with reference to FIG. 2.

A first step S1 of the method comprises determining a maximum storage capacity of the ring memory 4 of the motor vehicle 2 in the cloud 1. It is conceivable for this information to be stored in a database of the cloud 1 and/or to be retrieved from the motor vehicle 2.

A second step S2 of the method comprises determining, in the cloud 1, information that is required in order to achieve a predefined aim of the data collection campaign.

A third step S3 of the method comprises determining, in the cloud 1, data that are available in the motor vehicle 2. Here too, it is conceivable for this information to be stored in a database of the cloud 1 and/or to be retrieved from the motor vehicle 2.

A fourth step S4 of the method comprises selecting, in the cloud 1, the data to be stored in the ring memory 4 by means of the data collection campaign from the data available in the motor vehicle 2 on the basis of the maximum storage capacity of the ring memory 4 and the information that is required in order to achieve the predefined aim of the data collection campaign. The data are selected in such a way that the maximum storage capacity of the ring memory 4 is not exceeded. In particular, this is accomplished by determining which signals of the onboard electrical system of the motor vehicle 2 need to be tapped off, a recording period of the required signals, a signal resolution of the required signals and/or a sampling of the required signals.

A fifth step S5 of the method comprises defining, in the cloud 1, the data collection campaign on the basis of the selected data to be stored in the ring memory 4 by means of the data collection campaign.

A sixth step S6 of the method comprises transmitting the defined data collection campaign, in particular by means of wireless communication, from the cloud 1 that has defined the data collection campaign to the motor vehicle 2.

A seventh step S7 of the method comprises storing data in the ring memory 4 of the motor vehicle in accordance with the defined data collection campaign under the control of the data processing device 3 of the motor vehicle 2.

An eighth step S8 of the method comprises transmitting, in particular by means of wireless communication, the data stored in the ring memory 4 of the motor vehicle 2 from the motor vehicle 2 to the cloud 1 under the control of the data processing device 3 of the motor vehicle 2.

### LIST OF REFERENCE SIGNS

1 cloud
2 motor vehicle
3 data processing device
4 ring memory
5 system for data processing

S1-S8 steps of the computer-implemented method

1-10. (canceled)

11. A computer-implemented method for designing a data collection campaign for a motor vehicle, comprising:
determining a maximum storage capacity of a ring memory of a motor vehicle;
determining information that is required in order to achieve a predefined aim of the data collection campaign;
determining data that are available in the motor vehicle;
selecting the data to be stored in the ring memory by means of the data collection campaign from the data available in the motor vehicle on the basis of the maximum storage capacity of the ring memory and the information that is required in order to achieve the predefined aim of the data collection campaign; and
defining the data collection campaign on the basis of the selected data to be stored in the ring memory by means of the data collection campaign.

12. The computer-implemented method of claim 11, wherein the data is selected such that the maximum storage capacity of the ring memory is not exceeded.

13. The computer-implemented method of claim 11, wherein the data to be stored in the ring memory by means of the data collection campaign is selected from the data available in the motor vehicle on the basis of the maximum storage capacity of the ring memory and the information that is required in order to achieve the predefined aim of the data collection campaign by determining which signals of the onboard electrical system need to be tapped off, a recording period of the required signals, a signal resolution of the required signals, and/or a sampling of the required signals.

14. The computer-implemented method of claim 11, further comprising:
wirelessly transmitting the defined data collection campaign from a data processing device that has defined the data collection campaign to the motor vehicle.

15. The computer-implemented method of claim 14, further comprising:
storing data in the ring memory of the motor vehicle in accordance with the defined data collection campaign under the control of a data processing device of the motor vehicle.

16. The computer-implemented method of claim 15, further comprising:
wirelessly transmitting the data stored in the ring memory of the motor vehicle from the motor vehicle to a backend system.

17. A system for data processing, comprising means for carrying out the computer-implemented method of claim 11.

18. A motor vehicle, comprising:
a ring memory; and
a data processing device configured to control storage of data in the ring memory in accordance with the data collection campaign defined via the computer-implemented method of claim 11.

19. A computer program stored on a non-transitory medium and comprising commands that, when executed by a computer, cause the computer to carry out the method of claim 11.

20. A non-transitory computer-readable medium comprising commands that, when executed by a computer, cause the computer to carry out the method of claim 11.
